(19) United States
(12) Patent Application Publication
(10) Pub. No.: US 2016/0201386 A1
(43) Pub. Date: Jul. 14, 2016

(54) LAYERED MECHANICAL SECURITY BAR STRUCTURES

(71) Applicant: David L. GEORGE, San Jose, CA (US)

(72) Inventor: David L. George, San Jose, CA (US)

(21) Appl. No.: 14/914,407

(22) PCT Filed: Aug. 26, 2014
(86) PCT No.: PCT/US14/52625

§ 371 Date: Feb. 25, 2016

Related U.S. Application Data
(60) Provisional application No. 61/870,127, filed on Aug. 26, 2013.
(60) Provisional application No. 62/018,195, filed on Jun. 27, 2014.

(51) Int. Cl. E06B 9/02; E05B 39/00; E05B 17/00; E05B 15/16; E06B 9/01

(52) U.S. Cl. CPC E06B 9/02; E05B 15/1614; E06B 9/01; E05B 17/0079; E05B 39/002; E06B 2009/002

(57) ABSTRACT

Layered security bars (2, 4, 6, 8) are provided each having a structural outermost layer (10) and at least one ceramic layer (12) usually surrounding a core (14) to defeat attacks by thieves' tools. The outermost layer (10) is formed of a structural metal ordinarily an elongated tube (18, 36, 56, 72) having a case-hardened exterior (22) and a hollow interior (20, 28, 60, 74) containing discreet ceramic links (26). The embodiments include a simple bar (2), a deluxe prison bar (4), a rodded bar (6) with ceramic rod segments (68), and a shackle (8) with fish-spline links (78). Additional metallic and ceramic layered components are also provided.

This is a non-provisional application. Priority is claimed from U.S. 61/870,127 filed 26 Aug. 2013, U.S. 62/018,195 filed 27 Jun. 2014, and PCT/US2014/052625, all by the same current inventor.

### TECHNICAL FIELD

The present invention relates generally to security devices and structures and particularly for a methods and protocols for layered mechanical structures which are extremely resistant to cutting, breaking and tampering by criminal elements.

### BACKGROUND ART

Physical security structures, in the nature of locks, restraining bars, cords, posts, fences and other structures used to prevent theft and vandalism are a necessary part of human life and business, given the fallibilities of the species. The ingenuity of malefactors is legendary in that methods of defeating security often improve and are developed at least as rapidly as the structures themselves. Therefore, it requires continuing improvement in the structures developed to protect treasures and assets.

Of course, it is almost axiomatic that nothing is foolproof, or in this case “burglar-proof”, so it often becomes a matter of trade-offs in cost, inconvenience for legitimate users, difficulty of defeat and the amount of time it takes to defeat any security structure. In this light, anything that makes it more difficult or tedious for the attacker to overcome the security structure can result in great benefits in the protections of lives and property.

Over the years, many improvements have been made in construction materials have improved the efficacy of security bars, such as those used for building window and door bars, prison bars, traffic security posts, and the like. Improved alloys and the like have made it more difficult for thieves and the like to overcome them, but improved materials and sophistication in thieves' tools, such as rotary diamond cutters, laser cutters, hammer drills, and the like have kept pace. Consequently, a new method of approaching the problem is always desirable.

Accordingly, there is significant room for improvement and a need for better security structures, such as window bars, and prison bars which provide a very high degree of resistance to cutting, breaking or otherwise disabling attacks.

### DISCLOSURE OF INVENTION

Accordingly, it is an object of the present invention to provide a system for constructing layered and nested security bars and structures formed of materials having different properties in order to thwart thieves and vandals.

Another object of the invention is to provide a method and protocol for layering mechanical security structures.

A further object of the present invention is to provide a pattern of construction for security bar structures in order to provide security bars and posts which are adapted to hinder, slow and otherwise frustrate the improved tools and methods being used by malefactors.

Yet another object of the invention is to provide layered bars and tubes for security element which frustrate thermal cutting methods.

A further object of the present invention is to provide layers in security bars, the components including layers for: structural integrity and hardness; abrasive cutting resistance; heat cutting resistance; heat, extreme cold and electromagnetic dissipation; and miscellaneous forms of attack.

Briefly, the preferred embodiments of the present invention are security structures of an elongated nature all formed with common elements of a rigid, cut-resistant exterior layer and ate least one interior layer formed of a ceramic material. The security bar structures each utilize successive layering or interposing materials with different physical and conductive properties to defeat attempts to penetrate, break, cut or melt the structures. The simplest embodiments include layering a ceramic material inside of a metallic structural material, and most also include an inner core, which may include numerous elements inside of the ceramic. More extensive embodiments involve multiple layering and intermittent layering of the metallic and ceramic materials, and can include layers based on electromagnetic and thermally conductive materials as well. The deluxe embodiment is a high security enclosing bar, such as will be used in prison bars and the like, with multiple theft, breakage, and tamper defeating components contained within the inner core.

An advantage of the present invention is that it provides for security bars, columns and poles which are highly resistant to breakage, mechanical and laser cutting, melting, cold-shattering, and other failure conditions.

Another advantage of the invention is that it provides for security bars which impose significantly greater time and effort requirements in order to defeat the structures.

Yet another advantage of the present invention is that utilizing discreet longitudinal segments (links or, in some instances, “fish”) for internal materials, especially ceramic layers, particularly when spring loaded, results in lower potential for catastrophic crushing or breaking and significantly easier assembly as opposed to continuous tubes.

A further advantage of the present invention is that it takes advantage of significant developments in the creation and cost-effectiveness of ceramic materials which may be incorporated into security bars.

Yet another advantage of the present invention is that it facilitates incorporation of an endless variety of functional components in the protected inner core of the tubular bar-like structures.

Another advantage is that the protocol of the present invention is that it utilizes divergent physical and conductive properties of layered materials to protect against different methods of destructive attacks against the structures.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a perspective view of a simple security bar according to the invention, partially cut-away to illustrate interior components;

FIG. 2 is a cross sectional view of the bar of FIG. 1, taken along lines 2-2;

FIG. 3 is a cross sectional view of a deluxe embodiment of a prison bar according to the protocol of the present invention;

FIG. 4 is a cross sectional view of a security bar, similar to that of FIG. 2 but with an alternate construction; and

FIG. 5 is a partially cut-away plan view of a portion of a nonlinear security bar, in the form of a shackle as used in a bicycle lock or padlock.

### BEST MODE FOR CARRYING OUT THE INVENTION

The present invention is a set of related mechanical security bar structures which are highly resistant to disabling and tampering. The invention utilizes layering and nesting of divergent materials in order to thwart conventional methods used by thieves and vandals to disable or remove security barriers and fasteners from targets.

Examples of security bars according to the invention are shown in the views of the drawing and are referred to as example embodiments I, II, III, and IV respectively. Example Embodiment I is a basic security bar 2 for windows, doors, and fences, or the like, and is the simplest structure. Embodiment II is a deluxe full security bar 4, for use in special situations, such as in a prison, with additional features. Embodiment III is a second bar structure 6, similar to that of Example I, using intermittent rather than complete layering. Example Embodiment IV is a cut resistant curved bar structure 8, such as for a lock shackle, showing the use of intermeshed ceramic fish-spline links.

In its most basic form, the presently preferred embodiments of the invention are constructed according to a protocol utilizing a series of layers of divergent materials from the outside in, each layer having characteristics to counter/defeat typical techniques used by malefactors attempting to overcome the security aspects. Typically, the structures constructed according to the invention have a relatively hard structural outermost layer 10, with an intermediate layer 12 of a ceramic material and an inner core 14. In some embodiments the inner core 14 may actually be hollow, while in other instances, such as Embodiments I and III, it is filled with materials and/or core components 16 having special characteristics appropriate to the particular use. Other potential embodiments include enhancements such as additional intermediate layers, such as a heat conductor to syphon heat away from the area, case hardening of the outermost layer and other potential modifications which are uniquely suited to the particular application. The basic protocol applies to all embodiments.

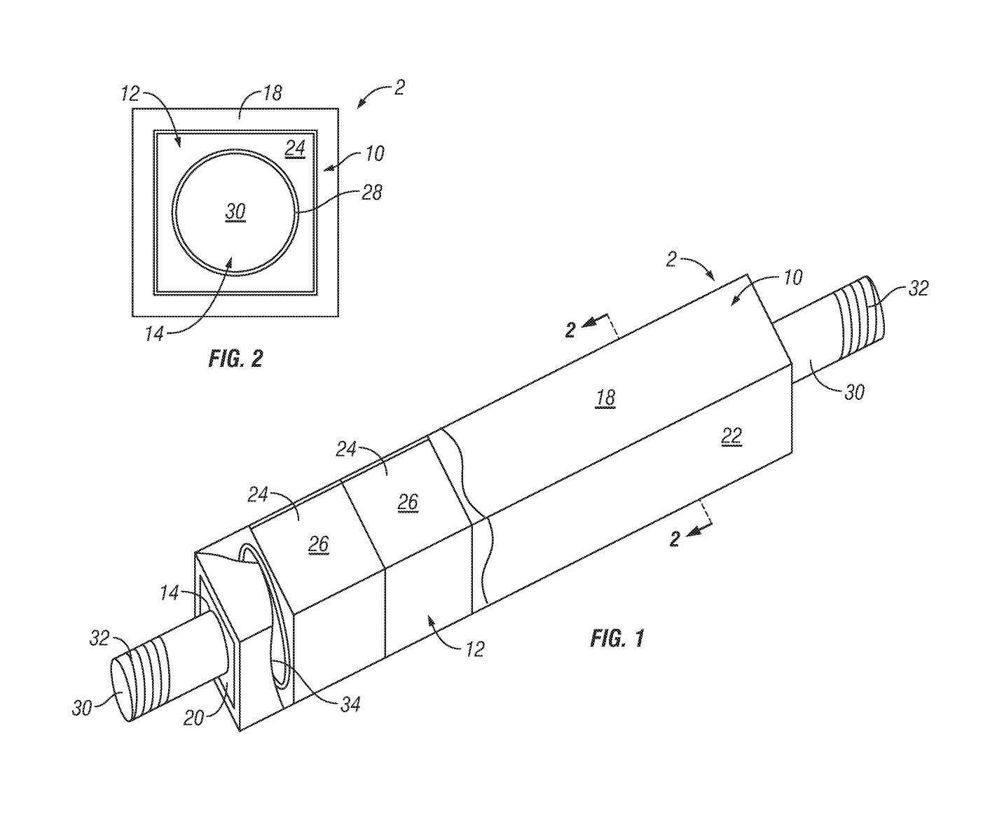

Referring now to FIGS. 1 and 2 (perspective and cross-sectional respectively), Example Embodiment I illustrates the typical security bar 2 constructed according to the method and protocol of the present invention. The particular security bar 2 is adapted for use for windows and doors in moderately high danger areas, such as commercial establishments subject to break-ins and theft (e.g. jewelry stores). In this embodiment the outermost layer 10 is a rectangular tube 18 having a rectangular bore 20 extending longitudinally therethrough. The rectangular tube 18 element is a structural metallic material such as steel, wrought iron, aluminum (which foils diamond cutters by fouling the disks) or the like and is a rectangular shape to particularly resist ring cutter attack. In higher security versions, the basic bar 2 may be provided with a case hardened outer layer 22.

Nested within the rectangular bore 20 is a rectangular ceramic tube 24 (preferably in discreet segments 26 aligned end to end) having a circular bore 28, together forming the ceramic layer 12. Although the core 14 could be hollow and empty for some applications of this embodiment, this particular version 2 is provided with a center rod 30 which both resists bending and further has opposing threaded ends 32 to provide a “tail” which allows the structure to be screwed/bolted into place.

The use of discreet segments 26 results in greater flexibility in assembly and construction than solid continuous ceramic tubing. Since there is no requirement that the ceramic layer provide significant structural support or any continuity for conductance, it is feasible to use short links or “slugs” which can be aligned within the rectangular tube 18 (see cut-away view in FIG. 1. This type of structure also permits insertion of longitudinal spaces in the ceramic layer 12 which can facilitate conductive communication between the outermost layer 10 and the core 14, when desirable. A compression spring 34 may also be provided at one or both ends (ordinarily held in place by adhesive or an end washer or cap—not shown) to apply compression force to the ceramic segments 26 such that if one is crushed or broken by drilling the adjacent segments 26 to fill the gap and trap the drill bit, thus inhibiting further attack.

This embodiment I is particularly effective in foiling thievery as the rectangular tube 18 provides strong structure, resistant to bending and breaking and is shaped to defeat common ring cutting techniques. The ceramic tube 24, preferably alumina or zirconium, is completely resistant to cutting if the outermost layer 10 is pierced and is also extremely effective against heat degradation, cold-shattering and laser cutting. The center rod 30 provides structural support to the ceramic tube 24 in order to prevent crushing and to minimize breakage and also serves to resist bending and crushing of the entire bar 2. In addition, as indicated above, the threaded ends 32 facilitate mounting. If the center rod 30 is omitted, or is not provided with tails 32, the bar 2 may also be welded into position or otherwise mechanically attached to the associated framework.

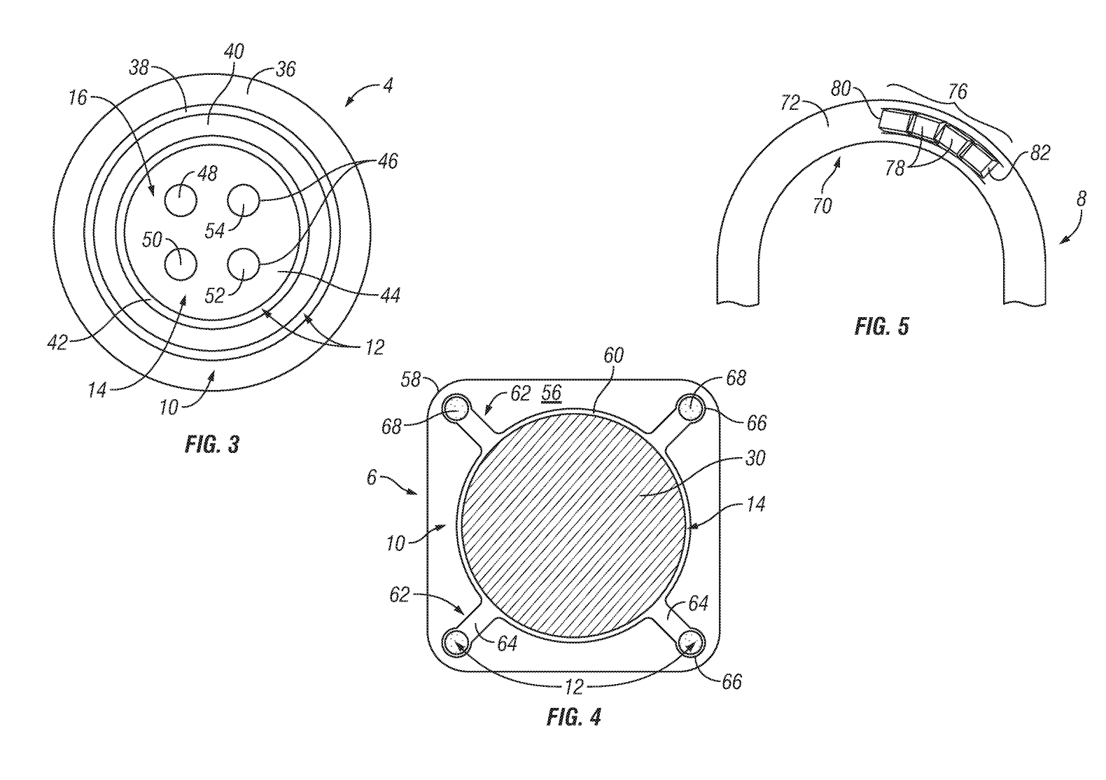

Example Embodiment II, shown in cross section in FIG. 3, is a specialized prison bar 4 adapted to have a deluxe structure for various purposes (the deluxe structure including additional elements which may also be incorporated in other embodiments). This embodiment II is especially adapted for high security applications, such as exist in prisons.

In the illustrated prison bar 4 the outermost layer 10 is a circular-cross-section metallic cylindrical tube 36 having a case-hardened surface 20. The case hardened surface 20 (preferably, the case-hardening being electromagnetically induced) is a further protection against cutting. Immediately within the cylindrical tube 36 is a first ceramic layer 38, similar in nature to those described earlier, but thinner. Nested within this is a thin conductive layer 40, preferably copper, to efficiently conduct heat away from (or, in the case of a super-cooled attack, toward) the affected area. A second ceramic layer 42 lies immediately within the conductive layer 40 to insulate a multi-bore core 44 and the core components 16 and also to provide an additional anti-cut layer.

The multi-bore core 44 may be a softer metallic material or even a plastic foam or composite material, as desired for the particular purpose. For example, as shown in FIG. 3, the multi-bore core 44 can have any number of longitudinal mini-tubes 46 extending therethrough to contain various anti-theft and anti-destruction core components 16.

In the deluxe prison bar embodiment 4 shown, the mini-tubes 46 include an anti-bend shorting structure 48 which includes a material adapted to shatter and short out a circuit to trigger an alarm in the event that the deluxe prison bar 4 is deformed out of shape and linear alignment. A second mini-tube 46 may include a sensitive audio pick-up 50 facilitating recording of sounds in the vicinity of the bar 4, which audio may be delivered to a central monitoring location for listening or recording. The audio pick-up 50 may be connected to the cylindrical tube 36 by insulated wiring, placed intermediate the discreet longitudinal segments 26 of the ceramic layers 40 and 44, to facilitate sound reception quality. A third mini-tube 46 may be a more conventional electromagnetic alarm 52 which is activated by heat, vibration or a combination of selected factors. The fourth mini-tube 46 in the prison bar 4 illustrated includes a marking fluid 54 (typically under pressure) which, when breached, spreads to tag the surroundings with indelible marks or scents which allow tracking of the person, clothing or equipment involved in the break.

Example embodiment III, as illustrated in FIG. 4 shows an alternate method of providing a layered structure in the form of a simple security bar 6 with intermittent ceramic shielding. Alternate Embodiment III is a variant of embodiment I which utilizes an intermittent, as opposed to continuous, ceramic layer 12 approach to defeat typical attacks.

In embodiment III, as in embodiment I, the outermost layer 10 of the security bar 6 is a metallic component in the form of a square tube 56 with rounded corners 58. In this case the square tube 56 is provided with a circular center bore 60, formed in the center of the metallic square tube 56 to contain the core 14, in this case a center rod 30 in the same manner as the basic bar 4. The square tube 56 is extruded in a manner such that is has four “ears” 62 extending radially toward the rounded corners 58 from the circular center bore 60. Each ear 62, in cross section, is shown to include a neck 64 and a longitudinal corner bore 66. Ceramic rod segments 68 are placed in the longitudinal corner bores 66 to provide the ceramic layer 12 of protection to prevent sawing or cutting to destroy the integrity of the simple bar 6. Compression springs 34 (not shown in this figure) may be inserted at one of both ends to maintain compression on the ceramic rod segments 68. The ends of the ears 62 will be sealed to maintain the ceramic rod segments 68 in place during use.

In the embodiment shown, the longitudinal corner bores 66 and associated ceramic rods 68 (which may be continuous, rather than segmented, in some versions) are situated in the corner portions of the square tube 56, but other versions may have additional iterations or use different spacing. The array of ceramic rods 68 forms a ceramic layer 12 which is intermittent, rather than continuous. The inner core components 16 in this embodiment IV can match that of embodiment I or be whatever other combination is desired for the particular use.

The intermittent ceramic layer 12 provided by the longitudinal ceramic rod segments 68 still provides an effective deterrent to cutting and will defeat any cutting technique presently known, since it provides sufficient ceramic materials in the peripheral area of the bar that mechanical, heat-based, diamond saw, and laser-type cutting techniques are ineffective.

The illustration of FIG. 5 shows Embodiment IV, in a partially cut-away view, as a segment of a shackle 8, such as would be used in a padlock or bicycle lock. The shackle 8 includes an arc portion 70 as shown which is curved. This embodiment 8 is provided to show that the security bars according to the present invention are not limited to linear constructions. This structure is described in more detail in the inventor's companion application for a Tamper Resistant Bicycle Lock.

The arc portion 70 is formed of a bent metallic cylinder 72 with a hollow center 74. An array 76 of ceramic fish-spline links 78 (also known as “fish” 78) is contained within the hollow center 74. The fish 78 are hollow cylindrical links tapered to have a convex end 80 and a concave end 82 and are placed in the array 76 such that a convex end 80 of one fish 78 will mesh with a concave end 82 of an adjacent fish. The fish 78 are preferably inserted into the hollow center 74 prior to bending the cylinder 72 into the arc. The intermeshing of the fish 78 allows bending without breakage. This type of ceramic layer 12 maintains the protocol of an outermost layer 10 of a hard metallic material and an interior ceramic layer 12 to provide multiple deterrents to breakage, cutting and other methods of tampering.

In each of the described example embodiments to be constructed in accordance with the inventive protocol, the functions are optimized by placement of ceramic materials intermediate or within structural materials. The ceramic materials provide significantly different physical and conductive properties than the typically metallic structural materials and thus present a much different challenge to the malefactors. The outermost layer 10 is typically hard and structurally strong, but may be subject to cutting by diamond cutters or the like. The ceramic layer 12, while it may be subject to breaking or crushing, is extremely resistant to physical cutting, laser cutting, and thermal attacks. This juxtapositioning of divergent materials allows the core 14 to be protected from all but the most determined and multi-pronged attacks.

As discussed above, the structural materials typically selected for the outermost layer 10 will be metallic, and may include, steel, stainless steel, wrought iron, aluminum, brass or any other material having significant structural strength and hardness.

Ceramic materials utilized in each ceramic layer 12, whether continuous or intermittent, may include: alumina; zirconium; titanium diboride, graphene, transparent aluminum and zirconia toughened alumina (zta). These materials can be cast, milled, extruded or otherwise formed into any desired shape.

Dimensions and shapes of the security structures are entirely dependent on the particular application and can vary widely. In particular, tubular structures can be in any form of hollow shape, including cross-sections in the form of ovals, non-square rectangles and other geometric configurations.

Many modifications to the above embodiments may be made without altering the nature of the invention. The dimensions and shapes of the components and the construction materials may be modified for particular circumstances.

While various embodiments have been described above, it should be understood that they have been presented by way of example only, and not as limitations.

### INDUSTRIAL APPLICABILITY

The method and protocol for constructing mechanical security bars and bent bar structures of the present invention is intended for use in any sort of circumstances where burglary, theft and other forms of trespass are feared. It is especially suited for construction of security bars for windows, doors and cells, as well as posts for blocking entrances to driveways and the like. In addition, the protocol is very well adapted for use in locking structures having shackles such as padlocks, door and gate locks, and utility meter locks.

The use of the protocol involving ceramic layers in or layered inside of structural layers results in requiring malefactors to invoke multi-pronged methods of attack in order to breach or defeat the security structure. In many cases, this will defeat the typical attempt and will, at the very least, require a great deal more time and effort on the part of the perpetrators. This may have the beneficial effect of causing the selection of easier targets. All of these factors result in greater protections of persons and property than are possible with security structures according to prior art methods and protocols.

Greater effectiveness in security is the cause of significant economic advantage. In addition, construction techniques utilizing intermittent layering or modular discreet longitudinal ceramic components can lessen material costs and/or simplify assembly.

For the above, and other, reasons, it is expected that the method and protocol for constructing mechanical security structures according to the present invention will have widespread industrial applicability. Therefore, it is expected that the commercial utility of the present invention will be extensive and long lasting.

What is claimed is:

1. A security bar structure comprising:
an outer layer of hard and strong structural material;
at least one hollow interior ceramic layer; and
at least one core component situated inside the innermost of said hollow interior ceramic layers.

2. The security bar of claim 1, wherein:
at least one of said hollow interior ceramic layers is formed of discreet longitudinal segments.

3. The security bar of claim 1 wherein
said outer layer is an elongated metallic tube having a hollow interior extending longitudinally therethrough.

4. The security bar of claim 3 wherein
said elongated metallic tube is a bar having a geometric cross-sectional shape;
said hollow interior is a regular geometrically shaped center bore; and
said hollow ceramic layer is formed of a ceramic tube subassembly adapted to slidably and relatively snugly fit within said geometrically shaped center bore.

5. The security bar of claim 4 wherein
said hollow ceramic tube subassembly is an array of discreet longitudinal segments.

6. The security bar of claim 5 wherein
a compression spring is provided at least one end of said array to apply longitudinal force to said discreet longitudinal segments.

7. The security bar of claim 2 wherein
at least one of said core components is center rod extending beyond said outer layer.

8. The security bar of claim 2 wherein
an inner one of said core components includes capillary tubes containing alarm structures and marking fluid.

9. The security bar of claim 1 wherein
said hard and strong structural material is selected from the group including: steel, case-hardened steel; stainless steel; wrought iron; brass and aluminum.

10. The security bar of claim 1 wherein
said ceramic layer is selected from the group including: zirconium; alumina; corundum infused alumina; corundum infused zirconia; titanium diboride; graphene; transparent aluminum; and zirconia toughened alumina (zta).

11. The security bar of claim 1 wherein
at least a portion of outer layer is bent into an arc; and
said ceramic layer contained within said arc includes an array of fish spline ceramic links.

12. A security bar comprising:
a metallic tube;
a hollow ceramic layer configured to nest within said metallic tube; and
at least one core component configured to be contained within said hollow ceramic layer.

13. The security bar of claim 12 wherein
said hollow ceramic layer is formed of an array of discreet longitudinal ceramic segments.

14. The security bar of claim 13 wherein
said array is longitudinally urged together by a compression spring.

15. The security bar of claim 12 wherein
at least one of said core components is center rod having threaded ends extending beyond said outer layer.

16. The security bar of claim 12 wherein
said core component includes capillary tubes containing alarm structures and marking fluid.

17. A security bar structure comprising:
an exterior metallic tube having an interior;
hollow ceramic segments strategically disposed within the material of said metallic tube to form one or more intermittent ceramic layer to shield said interior from cutting and sawing attacks by thieves' tools; and
at least one additional layer disposed concentrically and longitudinally within said hollow ceramic segments.

18. The security bar structure of claim 17 wherein
said at least one additional layer comprises a multi-bore core containing multiple longitudinal anti-theft core components selected from the group including: anti-bend shorting; an audio pickup; an alarm circuit; scent release materials; and marking fluid.

19. The security bar structure of claim 17 wherein
said hollow ceramic segments are fish-spline links.

18. The security bar structure of claim 17 wherein
said exterior metallic tube includes longitudinal cavities; and
said ceramic segments are disposed within said cavities.

19. The security bar structure of claim 17 and further including
lock cylinder and lock activation components at least partially contained within said interior; and
a cylinder guard structure including alternating metallic and ceramic layers protecting said lock cylinder from longitudinal attacks.
